(19) United States
(12) Patent Application Publication
(10) Pub. No.: US 2007/0269050 A1
(43) Pub. Date: Nov. 22, 2007

(54) SPEAKER POSITIONING APPARATUS FOR HUMAN EAR ALIGNMENT

(75) Inventors: GARY M. RAPPS, SUNRISE, FL (US); RAFAEL J. COBO, NORTH MIAMI BEACH, FL (US); JASON D. MCINTOSH, WESTON, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/419,552

(22) Filed: May 22, 2006

(51) Int. Cl. H04R 29/00; H04R 25/00

(52) U.S. Cl. 381/58; 381/384

(57) ABSTRACT

An alignment apparatus (110) for sound delivery of an audio device (100) is provided. The apparatus can include a speaker (130) mounted to an underside of a face plate (120) of the device, and a raised appendage (112) on the topside of the face plate. At least a portion of the raised appendage rests against at least a portion of a concha bowl (310) of an ear (230) to align a direction of sound from the speaker through the ear canal when the face plate is pressed against the ear. A positional cue of the raised appendage provides a repeatable reference location for positioning the audio device to align a centerline of the speaker with a centerline of the ear canal when coupled to the ear to maximize audio performance.

### FIELD OF THE INVENTION

The present invention relates to a sound delivery apparatus, and more particularly, to communication devices for delivery of sound to the ear.

### BACKGROUND

The use of portable electronic devices and mobile communication devices such as cell phones has increased dramatically in recent years. Due to the small size and shape of cell phones and sound speakers, users can be frequently annoyed with sound quality due to the delivery of sound from the cell phone when coupled to the ear. In general, the location of the cell phone against the ear may not provide acceptable audio for listening depending on the position of the cell phone. A user may need to move the cell phone around to find an optimal quality of sound delivery. That is, a user can have difficulty determining a placement of the cell phone against the ear that provides adequate sound quality. For example, depending on the position of the cell phone pressed against the ear, the quality of perceived audio that is output from the speaker to the ear can change dramatically. The user generally moves the phone around to find a suitable location around the ear that provides acceptable sound quality. This can be a source of frustration when the user must repeatably find and maintain a placement of the phone against the ear for multiple calls at different times. A need therefore exists for a sound delivery system that achieves repeatable sound delivery on a consistent basis.

### SUMMARY

Embodiments in accordance with invention relate generally to an apparatus for aligning a delivery of sound from a sound speaker to an ear. One embodiment of the invention is an alignment apparatus for sound delivery. The apparatus can include a speaker mounted to an underside of a face plate of the device, and a raised appendage on the topside of the face plate. During use, when the face plate is pressed against the ear, at least a portion of the raised appendage can rest against at least a portion of a concha bowl of an ear to align a direction of sound from the speaker through the ear canal. When a centerline of the device is approximately positioned along an ear-to-mouth reference line, the raised appendage accommodates a curved geometry of the human ear concha bowl, and provides directed delivery of sound from an approximate center line of the speaker to an approximate center line of the ear canal.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a top view of a speaker plate showing a raised appendage in accordance with the embodiments of the invention;

FIG. 2 is a depiction of the speaker plate of FIG. 1 pressed against an ear in accordance with the embodiments of the invention;

FIG. 3 is a side view of an ear and a view of a mouth;

FIG. 4 is a depiction of various embodiments of a raised appendage for providing alignment of sound delivery;

FIG. 5 is a cross section of the ear with an audio device, having the raised appendage, and placed against a face in accordance with the embodiments of the invention;

FIGS. 6, 7, and 8 depict one or more of the raised appendages of FIG. 4 in accordance with the embodiments of the invention;

FIGS. 9 and 10 show one protrusion of a cell phone positioned against an inner contour of a concha bowl of an ear in accordance with the embodiments of the invention;

FIGS. 11 and 12 show another protrusion on an extreme end of a cell phone positioned against a contour of a concha bowl of an ear in accordance with the embodiments of the invention; and

FIGS. 13 and 14 show yet another protrusion on an exterior end of a cell phone positioned against a contour of a concha bowl of an ear in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processor” can be defined as number of suitable processors, controllers, units, or the like that carry out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Embodiments of the invention provide an ergonomically structured protrusion, or raised appendage, on a face plate of an audio device that provides an aligned delivery of sound. The protrusion is fitted to the device in a manner such that the protrusion can comfortably rest against a predetermined location in a concha bowl of an ear when a user of the audio device presses the face plate of the audio device against the ear. The protrusion, when placed against the ear, provides tactile feedback and a corresponding positional cue to the user that allows the user to recall a physical placement of the audio device in order to maximize a quality of sound delivery. In particular, the protrusion establishes a reference position of the speaker of the audio device, wherein sound emanating from the speaker is delivered approximately along a center line of the speaker to a center line of the ear canal. In effect, the protrusion provides an alignment that positions an audio “sweet spot” of the speaker in a preferred location in the ear.

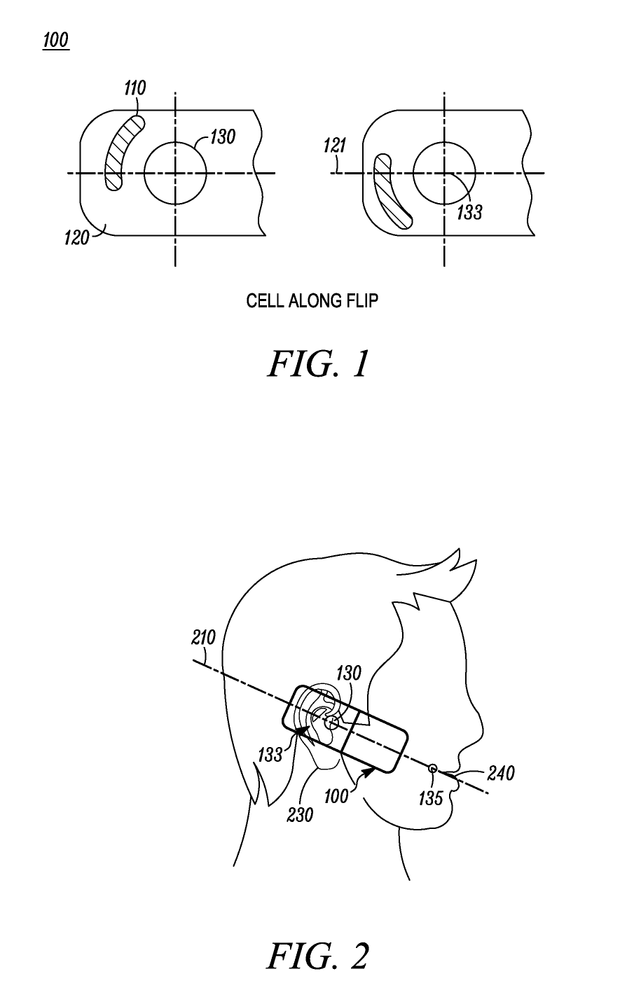

Referring to FIG. 1, a top view of a speaker plate showing a raised appendage is shown. The speaker plate 120 can be part of an audio device 100 that includes the raised appendage 110 and an attachment for mounting a speaker 130. The raised appendage 110 can provide tactile feedback and a positional cue to a user when the face plate 120 of the audio device 100 is pressed against an ear. That is, the raised appendage 110 can rest against an interior portion of an ear to position the audio device 100 for an aligned delivery of sound. In various arrangements, the raised appendage 110 can be attached to a structural support of the speaker 130, a speaker grill, or any other mechanical aspect of the speaker 130, and is not herein limited to attachment to only the speaker plate. The speaker plate 120, in various embodiments of the invention, can be a cell phone face plate, a plastic housing of a landline phone, or a face plate of a headset speaker, though is not herein limited to these. As another example, the audio device 100 can be a phone, a cell phone, a mobile communication device, a portable music player, or any audio device having sound production capabilities that can be physically coupled to the ear for delivering sound. As shown in FIG. 1, the raised appendage can be slid or pivoted to a mirror position to alternate between use of a left ear and a right ear. For example, the raised appendage 110 can be moved, pivoted, or slid to a mirror image position to switch from left to right ear use. A centerline 121 of the audio device 100 is also shown.

The raised appendage 110 provides a “device-to-ear” alignment mode for positioning a “sweet spot” of the speaker 130 in an optimum field over a user's ear canal, for a very wide variety of ear sizes and shapes. A “sweet spot” can correspond to a delivery of sound from the speaker 130 that provides a maximal delivery of sound and sound quality. For example, a sweet spot can be established when a centerline 133 of the speaker aligns with a centerline of the ear canal. The alignment establishes the principal direction of sound delivery that propagates from the speaker 130. The speaker centerline 133 is approximately perpendicular to the surface of the speaker 130. As depicted, the speaker centerline 133 projects approximately perpendicular out of the page. As an example, sound can emanate from the speaker 130 in an omni-directional pattern with the highest concentration of sound energy radiating perpendicular to the speaker 130. As another example, the maximal delivery of sound can correspond to a maximal signal power level (SPL). As another example, the maximal delivery of sound quality can correspond to a maximal intelligibility of audio. Notably, when the speaker is not properly positioned over the ear canal, sound can reflect off portions of the ear and can introduce distortions that affect the sound level and sound quality. The raised appendage alleviates these issues by establishing an alignment for a repeatable and consistent direction of sound delivery from the speaker into the ear canal.

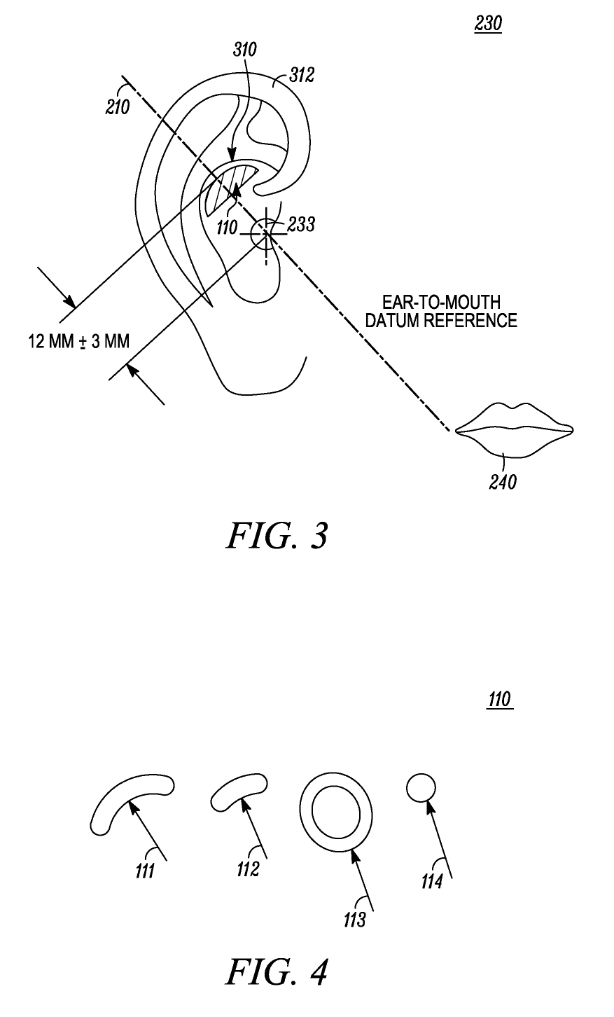

Referring to FIG. 2, a depiction of the audio device 100 of FIG. 1 is shown when the audio device 100 is pressed against an ear 230. An ear-to-mouth datum reference line 210 shows a positioning of the audio device during normal talking and listening. When the centerline 121 of the audio device 100 is approximately positioned along the ear-to-mouth reference line 210, the raised appendage 110 accommodates a curved geometry of the human ear concha bowl and aligns a direction of sound from the speaker 130 through the ear canal of the ear 230. In this configuration, the center line 133 of the speaker is aligned to a center line of the ear canal for establishing the direction of sound. In particular, when the audio device 100 is positioned with a microphone 135 positioned near a mouth, the sweet spot of the speaker 130 is aligned with a sweet spot of the ear canal. In another embodiment, the position of the speaker centerline 133 can be shifted with respect to the ear canal centerline 233 (See FIG. 3) to take advantage of sweet spot acoustic optimization when an offset of centerline produces enhanced audio. For example, the speaker 130 may deliver audio that sounds more “full” when the speaker is slightly shifted from a centerline. For example, cavities of the ear can create resonances that may accentuate certain frequencies for speech or audio when the speaker is positioned to take advantage of these effects. In practice, an acoustic analysis can be performed for determining the optimal positioning of the speaker 130 against the ear 230.

Referring to FIG. 3, a side view of the ear 230 in relationship to a location of the mouth 240 is shown. In particular, the ear canal centerline 233 and the ear-to-mouth datum reference line 210 is shown. The ear canal centerline 233 is the path approximately centered within the ear canal that propagates from the outer ear to the eardrum. As depicted, the ear canal centerline 233 projects approximately perpendicular into the page into the ear canal. As depicted, the ear-to-mouth datum reference line 210 is in the plane of the page. Notably, the raised appendage 110 can be positioned along an interior region of a concha bowl 310 of the ear 230. The raised appendage 110 can be ergonomically fitted to the concha bowl 310 for providing comfort and placement of the audio device against the ear 230. The direction of sound can be approximately perpendicular to the speaker 130 and can align the speaker center line 133 (See FIG. 2) with the ear canal centerline 233. Alternatively, the raised appendage can be positioned and fitted along the inner sulcus of the pinnae 312 of the ear 230 for aligning a delivery of sound through the ear canal from the speaker 130.

In one arrangement, an outer edge of the raised appendage 110 can be approximately 12 mm±3 mm away from the speaker centerline 133. This provides a nominal range of where a user would typically align the device to the ear. The position of the raised appendage provides a highly repeatable way of allowing the user to recall a position of the audio device such that the audio device touches the ear in the same place. To note, the location of the raised appendage has been derived through anthropometric data on a wide range of ear sizes. The data reveals the positional “cue” across the range of ear sizes and shapes. In particular, the positional cue of the raised appendage provides the user a reference position that is easy to duplicate (find with respect to the ear) each time and provides the positional alignment to achieve the optimized “sweet spot” coupling to the ear to maximize audio performance. The raised appendage 110 enables a user to position a sweet spot of the speaker in a predetermined location for providing a repeatable quality of acoustic sound delivery. In addition, the raised appendage provides a tactile feel that allows the user to physically recognize that the audio device has been aligned to the ear within a small variation, which provides the user within an “audio window” of the sweet spot.

Referring to FIG. 4, an illustration of the various embodiments of the raised appendage 110 of FIG. 3 for providing alignment of sound delivery is shown. The shape of the raised appendage 110 is ergonomically structured to fit one or more contours of the ear 230 for establishing a reference position for sound delivery. The ergonomic fit can be accomplished through one of a number of geometric shapes that can contain a curved section and that can contact the concha bowl to provide the positional cue while maintaining comfortable fit. For example, the shape of the raised appendage can be a curved section 111, a kidney-bean section 112, a donut 113, or a conical form 114. The raised appendage can also be replaceable or interchangeable on the cell phone face plate. A raised appendage can be defined as any structure that at least rises above a speaker and is configured to aligh the speaker with a human ear canal. The term “protrusion” can also be referenced with similar meaning to the term “raised appendage”. A protrusion, however, develops from the same material as the face plate. For example, a protrusion can be created by lifting or raising a portion of the material that is already part of the face plate. A protrusion can extend from the surface of the face plate to provide a physical reference for positioning the cell phone. The protrusion can be molded from a resilient material and be permanently mounted on the speaker face plate 120, with a corresponding recess in the audio device housing. As one example, the protrusion can be manufactured using a standard 2-shot rubber over-molding process.

In contrast, a raised appendage can be composed of a separate material, created distinctly from the face plate, that is placed or positioned on the face plate for providing a positional reference. The raised appendage 110 can be attached to the face plate 120 by various means including glue, plastic, or heating though is not herein limited to these. In one arrangement, the raised appendage 110 can be a removable appendage that can be reattached at a defined location. For example, the raised appendage 110 can fit within a molded recess of the face plate. The raised appendage 110, or protrusion, can have a softness that is approximately between 5 and 30 durometers, wherein a 30 durometer is stiff and hard and a 15 durometer is similar feel as the ear. For example, 15 Shore-A is a close approximation to the feel of the persons' actual ear. The softness provides a tactile feel and positional cue that allows a user to establish a comfortable and repeatable position of the audio device for a repeatable delivery of sound and sound quality.

The raised appendage 110, or the protrusion, can be deployable, that is, can protrude, for example, as a result of opening a flip lid such as that on a cell phone, or by means of a trigger release, such as a button. Alternatively, the raised appendage 110 can protrude from the face plate 120 in response to a mechanical event or a software controlled event. As another example, the raised appendage 110 can be an airbladder that inflates, or a molded device that articulates with a spring recoil. The raised appendage 110, or the protrusion, can be a resilient elastomer, an inflatable pouch, a metallic form that deploys, etc. The deployed appendage, or the protrusion, can be located accordingly so as to locate the speaker's sweet spot (center line) with respect to the user's ear canal centerline.

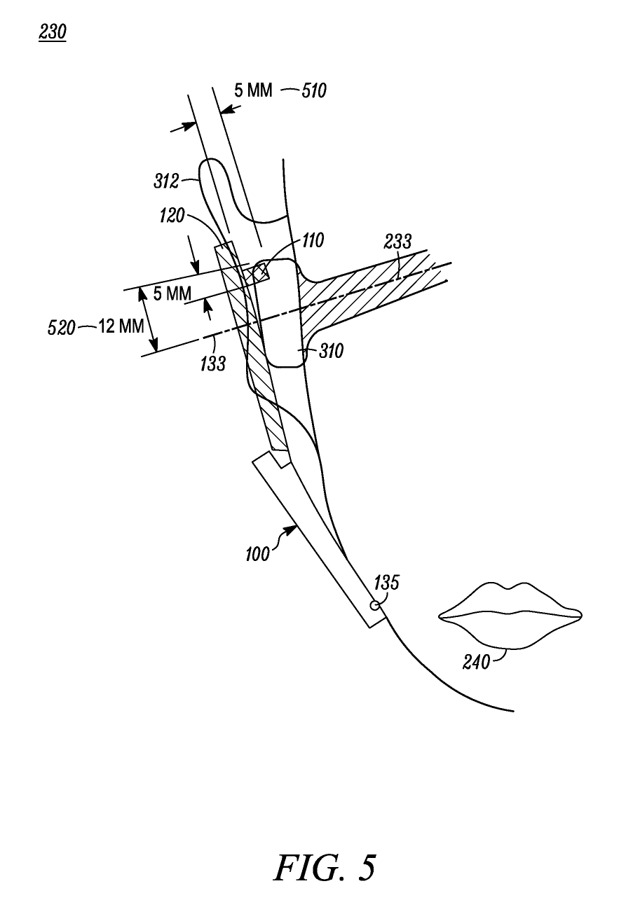

Referring to FIG. 5, a cross section of the ear 230 with the audio device 100 having a raised protrusion 110 and placed against a face is shown in accordance with the embodiments of the invention. In particular, the raised appendage 110, when combined with the angle of the audio device 100 when resting against the user's face, aligns the speaker centerline 133 with the ear canal centerline 233 to provide directed delivery of sound through the ear. That is, when the audio device 110 is positioned with the microphone 135 positioned nearest the user's mouth 240, that angle with respect to the user's head, in combination with the raised appendage 110, positions the speaker center line 133 in an aligned arrangement to the ear canal center line 233. Notably, the protrusion 110 is molded and positioned based on human factors particular to the audio device. That is, various audio devices 100 will each rest against a user's face in different configurations. For example, a flip phone that opens less than 180 degrees will result in a face plate angle pressed against the ear that has a different angle from a monolithic phone that rests flush against the face.

Notably, the protrusion 110 is based on the human factors of the device, and is constructed to properly align the sweet spot of the speaker 130 with the sweet spot of the ear canal. In one embodiment, the audio device 100 can be a cell phone that is pressed against the ear. The raised appendage 110, or protrusion, can be ergonomically structured on the face plate 120 of the cell phone. When the cell phone is moved to a normal position covering the ear's concha bowl (e.g. surrounding the ear canal), for allowing the user to hear the audio delivered by the speaker 130, the raised appendage 110 contacts the ear 230 in a manner that positions the sweet spot of the speaker 130 in a preferred location. This positioning permits optimized acoustic delivery to the ear, without dependence on ear size and shape. The protrusion 110 touches the ear at a predetermined point to align the speaker 130 with the ear 230.

Recall, the raised appendage 110 provides a physical reference, or alignment cue, that is derived as a result of the addition of the raised appendage 100. In particular, the shape and location of the raised appendage 100 on the cell phone has been derived through anthropometric data (characterization of the human body through physical measurements) to provide the necessary positional cues across a wide range of ear sizes and shapes. This ergonomic protrusion aids the user by providing a physical reference, or alignment cue, for consistently locating the cell phone in an acoustically optimal location. This is achieved through a haptic (relating to the sense of touch) response from the user as the protrusion touches the ear. This protrusion is structured to comfortably fit the variety of contours of the ear due to its shape and position. In one arrangement, based on collected anthropometric data, the depth of the protrusion 110 is approximately 5 mm+3 mm into the concha bowl 310. The depth of the protrusion extends downwards from the surface of the face plate into the concha bowl when the surface of the face plate is positioned against the ear.

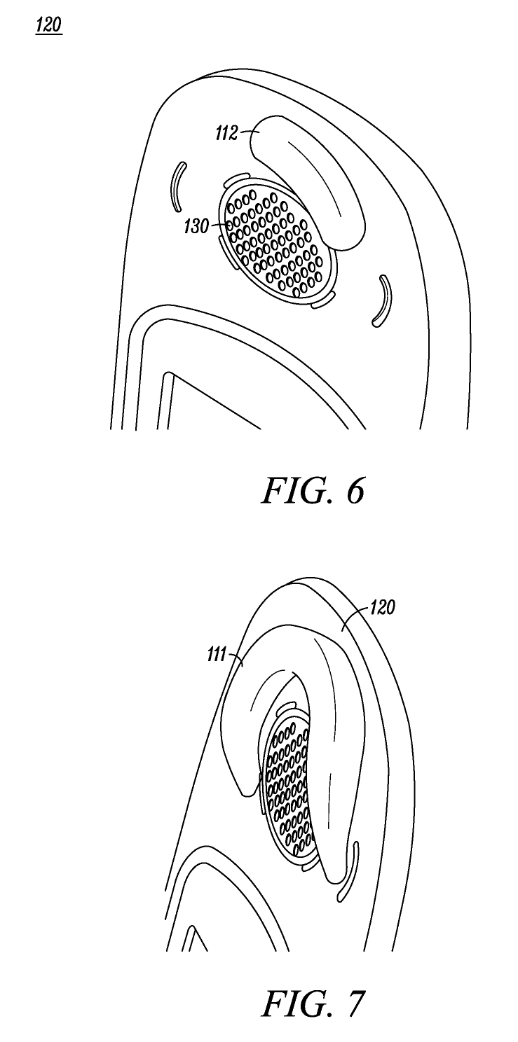

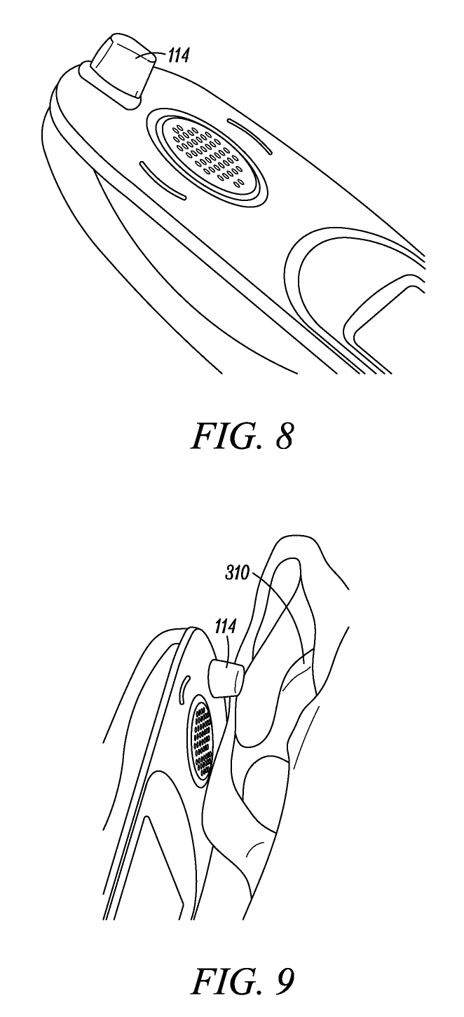

As an example, FIG. 6, shows a positioning of the kidney shaped raised appendage 112 of FIG. 4 on a cell phone face plate. As another example, FIG. 7, shows a positioning of the curved raised appendage 111 of FIG. 4 on a cell phone face plate. As yet another example, FIG. 8, shows a positioning of the conical form raised appendage 114 of FIG. 4 on a cell phone face plate. These embodiments provide for a selection of shapes that provide a synergistic cooperative action that mates the cell phone optimally over the user's ear. The shape of the appendages (111-114) (or protrusions) are ergonomically structured to comfortably fit the variety of contours of the ear providing the reference position. The shape, contour, height, and degree of softness (durameter) of the raised appendage contribute to providing this reference position.

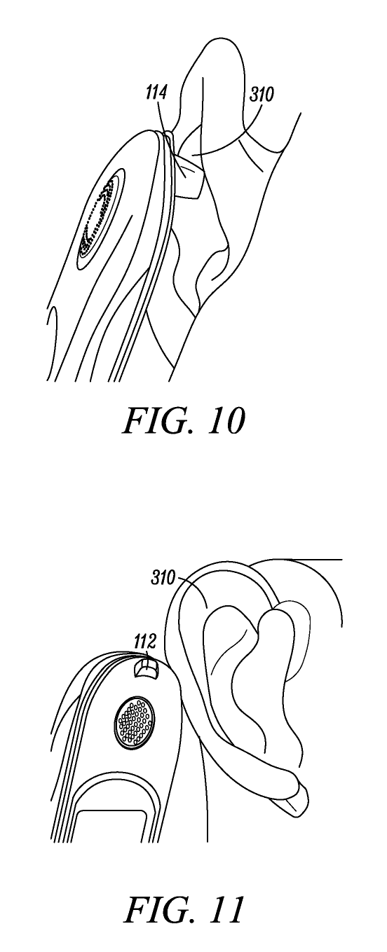

FIGS. 9 and 10 show one protrusion of a cell phone positioned against an inner contour of a concha bowl of an ear in accordance with the embodiments of the invention. The alignment apparatus of FIGS. 9 and 10 provides sound delivery and comprises a speaker mounted to an underside of a face plate of the device, and a raised appendage on the topside of the face plate. At least a portion of the raised appendage rests against at least a portion of a concha bowl of an ear to align a direction of sound from the speaker through the ear canal when the face plate is pressed against the ear. The protrusion corresponds to the conical form of the raised appendage 114 of FIG. 4. In particular, the conical form of the raised appendage comfortably rests against an inner portion of the concha bowl 310.

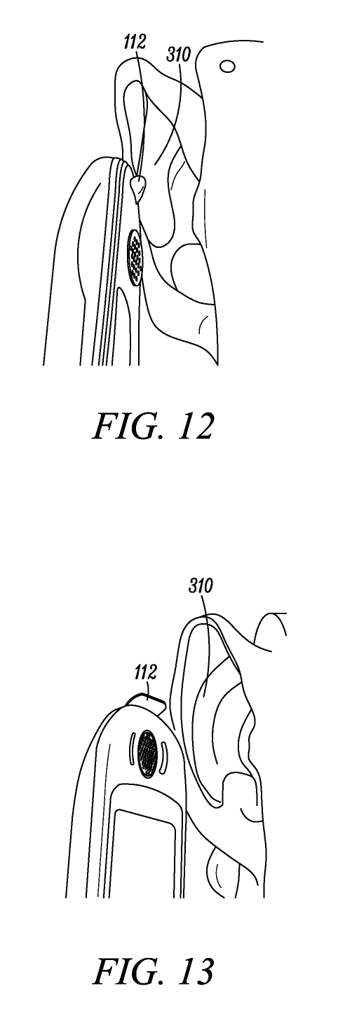

FIGS. 11 and 12 show another protrusion on an extreme end of a cell phone positioned against a contour of a concha bowl of an ear in accordance with the embodiments of the invention. The haptic alignment apparatus of FIGS. 11 and 12 provides sound delivery suitable for use on a cell phone. The apparatus comprises a speaker mounted to an underside of a cell phone face plate, and a raised appendage on the topside of the cell phone face plate. When the cell phone face plate covers a concha bowl of an ear, at least a portion of the raised appendage fits against at least a portion of the interior of the concha bowl to align a direction of sound from the speaker through the ear canal for positioning a sweet spot of the speaker at a predetermined location in the ear. In particular, the raised appendage is at a farthest region of the face plate 120 from the speaker 130. In this configuration, the raised appendage 110 can be positioned within the concha bowl 310. This configuration can be desirable when the speaker 130 is relatively close to the outer edge of the cell phone.

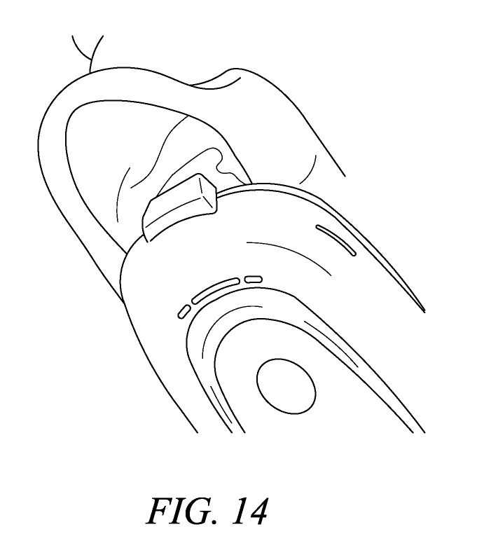

FIGS. 13 and 14 show yet another protrusion on an exterior end of a cell phone positioned against a contour of a concha bowl of an ear in accordance with the embodiments of the invention. The audio device of FIGS. 13 and 14 provides for sound delivery, and comprises a speaker for delivering sound through an ear canal, and a protrusion 112 connected to an attachment portion of the speaker. At least a portion of the protrusion 110 rests against at least an interior portion of a concha bowl 310 of the ear to align a direction of sound from the speaker through the ear canal when the speaker is placed near the ear. In particular, the raised appendage is on an exterior region of the cell phone and may not even be on the face plate 120. In this configuration, the raised appendage 110 can also be positioned within the concha bowl 310. This configuration can be desirable when the speaker 130 is relatively close to the outer edge of the cell phone. The reference position created by the placement of the raised appendage 110 in the concha bowl locates the speaker 130 relative to a reference spot inside the user's ear concha bowl.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

1. An alignment apparatus for sound delivery of a device, comprising:
a speaker mounted to a face plate of the device; and
a raised appendage on the face plate,
such that at least a portion of the raised appendage rests against at least a portion of a concha bowl of an ear to align a direction of sound from the speaker through the ear canal when the face plate is pressed against the ear.

2. The alignment apparatus of claim 1, wherein when a centerline of the device is approximately positioned along an ear-to-mouth reference line, the raised appendage accommodates a curved geometry of the human ear concha bowl.

3. The alignment apparatus of claim 1, wherein an outer edge of the raised appendage is approximately 9 mm to 15 mm away from a centerline of the speaker, and a depth of the protrusion is approximately 2 mm to 8 mm.

4. The alignment apparatus of claim 1, wherein a shape of the raised appendage is ergonomically structured to fit one or more contours of the ear for establishing a reference sound delivery position, and the shape comprises one from the set of a curved section, a kidney-bean section, a donut, or a conical form.

5. The alignment apparatus of claim 1, wherein the raised appendage can be slid or pivoted to a mirror position to alternate between use of a left ear and a right ear.

6. The alignment apparatus of claim 1, wherein the raised appendage is ergonomically fitted to at least a portion of the concha bowl.

7. The alignment apparatus of claim 1, wherein the raised appendage is close to an extreme end or an exterior of the face plate.

8. An audio device for sound delivery, comprising:
a speaker for delivering sound through an ear canal of an ear;
a protrusion connected to an attachment portion of the speaker;
such that at least a portion of the protrusion rests against at least an interior portion of a concha bowl of the ear to align a direction of sound from the speaker through the ear canal when the speaker is placed near the ear.

9. The audio device of claim 8, further comprising a microphone, such that when the audio device is positioned with the microphone positioned near a mouth, a center line of the speaker is aligned to a center line of the ear canal for directing a delivery of sound.

10. The audio device of claim 9, wherein the direction of sound is approximately perpendicular to the speaker along the speaker center line.

11. The audio device of claim 8, wherein a shape of the protrusion is ergonomically structured to fit one or more contours of the ear for establishing a reference sound delivery position, and the shape comprises one from the set of a curved section, a kidney-bean section, a donut, or a conical form.

12. The audio device of claim 8, wherein a softness of the protrusion is approximately between 5 and 30 durometer Shore A.

13. The audio device of claim 12, wherein the softness provides a tactile feel and the protrusion is a positional cue that allows a user to establish a repeatable position of the audio device for a consistent delivery of sound quality.

14. The audio device of claim 9, wherein an outer edge of the protrusion is approximately 9 mm to 15 mm away from the centerline of the speaker, and the depth of the protrusion is approximately 2 mm to 8 mm.

15. The audio device of claim 8, wherein the protrusion touches the ear at a predetermined location in the ear to align the speaker with the ear.

16. The audio device of claim 8, wherein the protrusion provides a physical reference for consistently locating the device in an acoustic location.

17. A haptic alignment apparatus for sound delivery suitable for use on a cell phone, comprising:
a speaker mounted to an underside of a cell phone face plate; and
a raised appendage on the topside of the cell phone face plate,
wherein when the cell phone face plate covers a concha bowl of an ear, at least a portion of the raised appendage fits against at least a portion of the interior of the concha bowl to align a direction of sound from the speaker through the ear canal for positioning a centerline of the speaker at a predetermined location in the ear.

18. The haptic alignment apparatus item of claim 17, further comprising:
a microphone for capturing audio, such that when the cell phone is positioned with the microphone positioned near a mouth, the positioning of the centerline of the speaker is substantially aligned to a centerline of the ear canal.

19. The haptic alignment apparatus of claim 17, wherein the raised appendage is molded from a resilient material that is permanently mounted on the cell phone face plate.

20. The haptic alignment apparatus of claim 17, wherein the raised appendage is interchangeable on the cell phone face plate.
